(19) United States
(12) Patent Application Publication
(10) Pub. No.: US 2003/0200830 A1
(43) Pub. Date: Oct. 30, 2003

(54) Gearwheel with a damping device

(75) Inventors: Benedikt Schauder, Schweinfurt (DE); Gerald Buer, Muhlhausen (DE); Bernhard Schierling, Kurnach (DE); Peter Schulze, St. Simeon de Bressieux Frankreich (FR)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/409,231

(22) Filed: Apr. 8, 2003

(30) Foreign Application Priority Data
Apr. 25, 2002 (DE) 102 18 453.4

(51) Int. Cl. F16H 55/17

(52) U.S. Cl. 74/439; 74/443

(57) ABSTRACT

A gearwheel, in particular a chain wheel, for the transmission of torque from one shaft to another, has a form-locking fastening device for fixing it on the shaft in a defined position. The fastening device is a bowl-shaped driver part and has a damping device for the damping of torsional oscillations, the damping device including of a leg spring with two legs which are angled parallel to one another and surround, under prestress, a driver extension on the driver part and a driver nose on the gearwheel. The angular position of the gearwheel on the shaft is defined by the force of the prestressed leg spring, the torsional oscillations bringing about a deflection of the gearwheel on the shaft through a particular angle of rotation in both directions of rotation and therefore being smoothed. The cost-effective and space-saving form of construction of the gearwheel, which forms a structural unit with the driver part and the leg spring, is advantageous.

### BACKGROUND OF THE INVENTION

1. Field of the Invention

The invention relates to a gearwheel, in particular a chain wheel, for the transmission of torque from one shaft to another, having a form-locking fastening device for fixing it on the shaft in a defined position.

2. Description of the Related Art

Gearwheels of the above-mentioned type are connected to the shaft, for example, by means of a tension spring, the tension spring being arranged in a groove there when the gearwheel is pushed onto the shaft, the gearwheel likewise having an axially running groove on the inside diameter for surrounding the tension spring. This is a rigid connection between the gearwheel and the shaft which transfers all the forces which arise, that is to say even force peaks in the event of oscillations in the transmission system. Reducing these force peaks to the normal magnitude of the transmission forces is the task of a damping device, for example in the form of an assembly part, consisting of elastomeric material, which, in motorcycles, may be arranged in the chain mechanism in the rear wheel between the chain wheel and the hub of the running wheel. Here, the force peaks resulting from the unevenness of the internal combustion engine are diverted into the assembly part acting as a torsion spring, the elastomeric material having a high degree of material damping, in order thereby to achieve a smoothing of the force flux.

Particularly in the drive of shafts in internal combustion engines, torsional oscillations occurring due to the unevenness of the load cycles on the crankshaft may be transmitted to other shafts arranged in the internal combustion engine, with the result that premature wear may be established on the transmission elements, in particular on chains.

### SUMMARY OF THE INVENTION

The present invention proposes, for the damping of these torsional oscillations, a gearwheel which, together with the fastening device and the damping device, constitutes an assembly in a form such that the fastening device is a bowl-shaped driver part and the damping device is a leg spring which connects the gearwheel and the driver part to one another in a pivotally movable manner. The leg spring has two legs which are angled parallel to one another and surround, under prestress, a driver extension on the driver part and a driver nose on the gearwheel. The angular position of the gearwheel on the shaft is defined by the force of the prestressed leg spring, the torsional oscillations bringing about a deflection of the gearwheel on the shaft through a particular angle of rotation in both directions of rotation and thereby being smoothed.

The bowl-shaped driver part is slid over a shaft end and is connected to the latter by means of a screw connection and/or a press-fit connection, preferably a form surface ensuring a defined angular position of the driver part on a countersurface of the shaft. Furthermore, the driver part has a cylindrical extension with a snap device, on which cylindrical extension the gearwheel is mounted and, above all, is secured axially. Furthermore, the cylindrical extension is the base for the leg spring which is arranged between the driver part and the gearwheel and the legs of which project beyond the height of the form surface and surround, under prestress, the driver extension which is likewise arranged in the prolongation of the form surface. However, the legs do not only exert high pressure on the driver extension, but also on the driver nose in the gearwheel, with the result that the latter is held in a rotationally fixed position in relation to the driver part, at rest and also during operation when no particularly high torsional oscillations occur.

In the event, however, that, at low rotational speeds and at a high average working pressure of the internal combustion engine, the unevenness of its crankshaft and therefore the torsional oscillations increase, the driver nose is displaced to a greater extent with respect to the driver extension, that leg of the leg spring which is under pressure in each case by means of the driver nose being lifted off from the driver extension and being returned there again, after which the same movement process takes place on the other side with the other leg. Torsional oscillations of lower amplitudes take place in the elastic range of the legs, without these lifting off both from the driver extension and from the driver nose.

Straightforward cushioning by means of the legs contributes to a great extent to the smoothing of the torsional oscillations, in particular the force peaks. Damping by means of a frictional connection adds to the function of the arrangement of the structural unit inasmuch as the leg spring, at a contact point of its turn just before the angling toward the legs, generates friction which is directed opposite to the spring movement when a leg is deflected, which converts torsional oscillations into heat. The pressure force within the turn may be made adjustable by means of the fastening of the driver part on the shaft, this placing special requirements on the type of axial fastening, to be precise on a screw connection or a snap connection. Of course, the torsional amplitudes move within a narrow range which should preferably be defined via a torsional-oscillation limiter. This consists, here, of a nose which is located on the driver part and which cooperates with a stop on the gearwheel, this stop being designed for both directions of rotation.

Moreover, leg springs are known from many fields of use, such as, for example, from U.S. Pat. No. 5,904,069, where a leg spring with two legs angled approximately parallel to one another ensures the return of an operating element into its initial position after an operating action. The gearwheel together with its driver nose is slightly comparable to the operating element of U.S. Pat. No. 5,904,069, although the functioning of the proposal of the present invention differs considerably.

Since elastomeric material has proved successful in the art for the damping of torsional oscillations, an assembly part consisting of this material is appropriate for connecting the driver part to the gearwheel, and this assembly part should be mounted under prestress preferably in the free space between the two parts. In terms of the amount of space required, however, this form of construction has a disadvantage, as compared with that using the leg spring, and, moreover, measures for maintaining the accuracy of the position of the gearwheel would also have to be taken.

It is simpler for assembly purposes, but more complicated and more cost-intensive in terms of production, to vulcanize the gearwheel together with the driver part by the injection of an elastomeric mass into the free space present between the two parts, thus resulting in a gearwheel assembly which can be connected to the shaft in the same way as the driver part, in the way described above.

The set object of the present invention is, therefore, to provide a gearwheel, in particular a chain wheel, for the transmission of torque, having a form-locking fastening device for fixing it on a shaft in a defined position, and being connected cost-effectively, and without an appreciable additional outlay in terms of construction space, to a device for the damping of torsional oscillations.

According to the invention, a driver part arranged rotatably on the gearwheel is connected to the gearwheel via a damping device which allows a defined angle of rotation between the driver part and the gearwheel for the damping of vibrations.

An exemplary embodiment of the gearwheel with a damping device for the smoothing of force peaks arising from torsional oscillations is explained with reference to several drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a section view of an assembly consisting of a gearwheel, a driver part and a leg spring;

FIG. 2 is a plan view of the assembly with a flat surface on the driver part and with legs of the leg spring which surround a driver extension on the driver part and a driver nose on the gearwheel;

FIG. 3 is a perspective view of the assembly;

FIG. 4 is a plan view of the leg spring and its orientation of the driver part with respect to the gearwheel; and

FIG. 5 is a section view of the contact point of the turn of the leg spring and a snap connection for axially fixing the gearwheel on the driver part, as an enlargement from FIG. 1.

### DETAILED DESCRIPTION OF THE PRESENTLY PREFERRED EMBODIMENTS

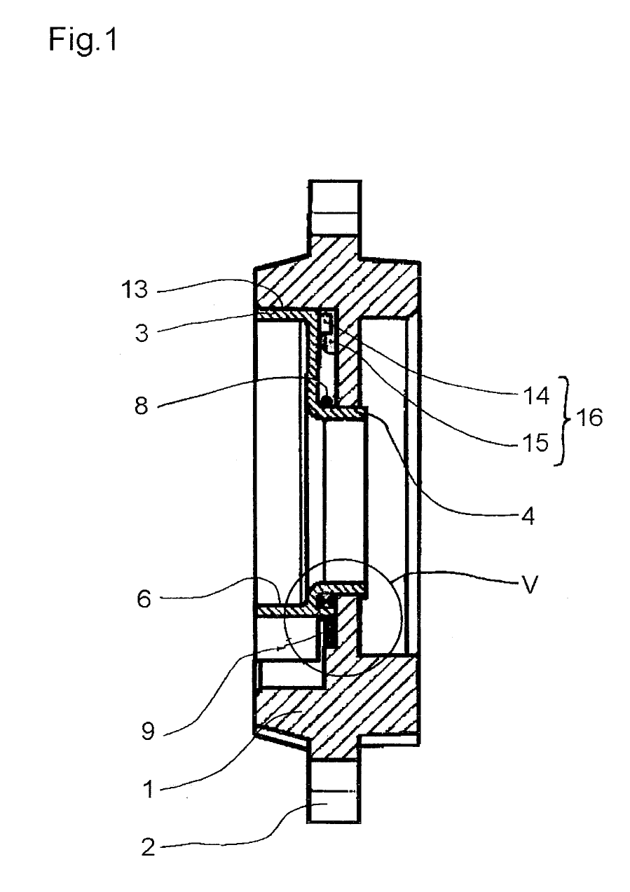

Referring to FIG. 1, a gearwheel 1 having teeth 2, in particular a chain wheel, has a first bearing surface 13, at which a driver part 3 is mounted. The driver part 3 is connected to a cylindrical extension 4, on which are arranged a second bearing point 5 and a snap connection 12, where the gearwheel 1 is secured axially at its inside diameter and may likewise be mounted in a pivotable manner. According to FIG. 1 and FIG. 5, as an enlargement V from FIG. 1, it becomes clear how the driver part 3 is arranged in the gearwheel 1 and how a leg spring 8 is laid around the cylindrical extension 4 between the driver part 3 and the gearwheel 1. Moreover, in the same plane of the leg spring 8, a torsional-oscillation limiter 16 is arranged, which consists of a nose 14 on the driver part 3 and of a double-acting stop 15 on the gearwheel.

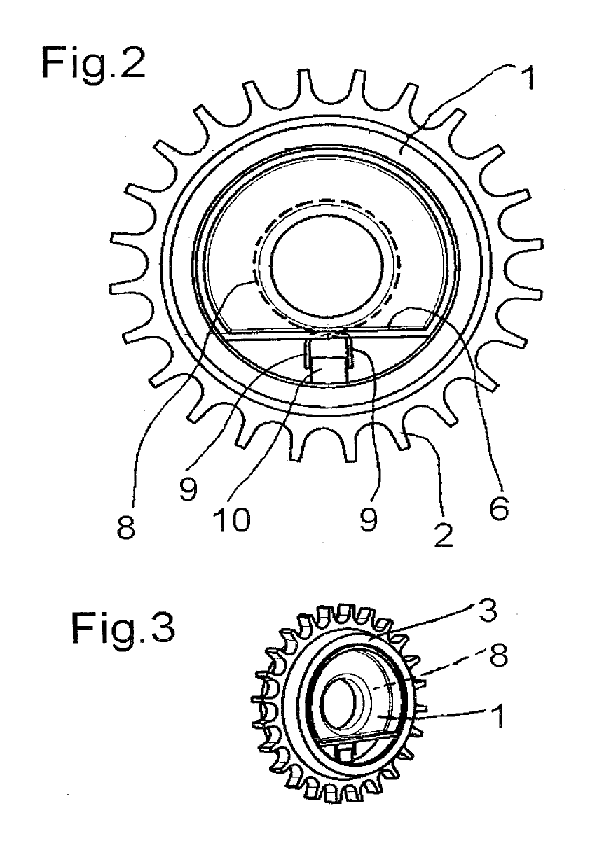

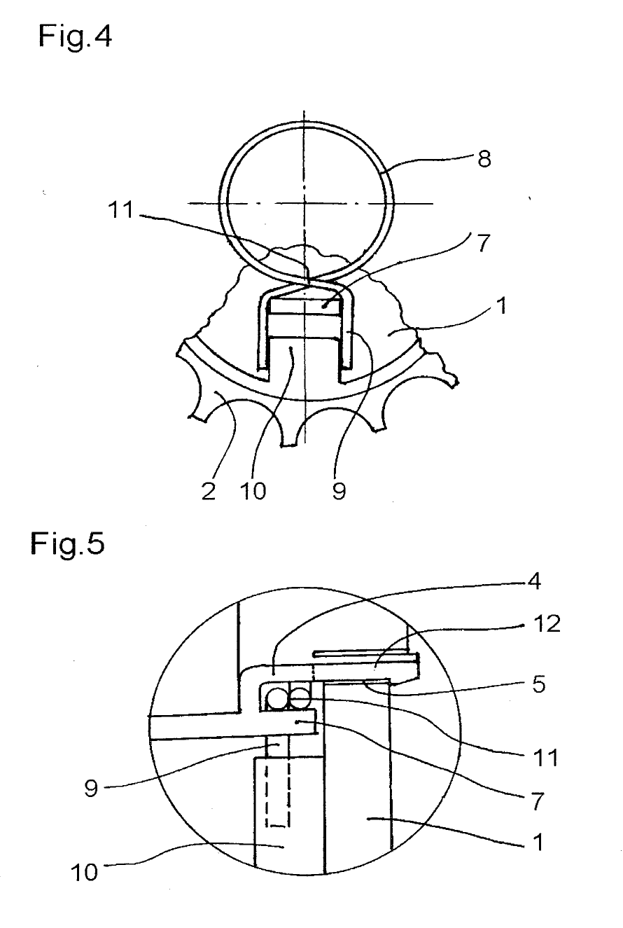

FIG. 2 shows a flat surface 6 on the driver part 3, which fits against a flat surface on the shaft, in order to ensure a defined angular position of the driver part 3 on the shaft. According to FIG. 4, the flat surface 6 extends in the direction of the cylindrical extension 4 to a driver extension 7, against the two sides of which a respective leg 9 of the prestressed leg spring 8 comes to bear. Moreover, in terms of the angular position of the gearwheel 1 in relation to the driver part 3 and therefore in relation to the shaft, the two legs 9 guide the shaft via a driver nose 10, so that the gearwheel 1 can be rotated with respect to the driver part 3 only in conjunction with the deflection of one of the two legs 9. As already mentioned, the cushioning by means of the legs 9 for the smoothing of the torsional oscillations, in particular the force peaks, is additionally supplemented by damping by means of a frictional connection, in that the leg spring 8 is pressed together at a contact point 11 at its turn. During the rotation of the gearwheel 1 with respect to the driver part 3, this generates friction due to the deflection of the legs 9.

The advantage of the proposal of the invention is the cost-effective and space-saving form of construction of the gearwheel 1 which, as a structural unit with the drive part 3 and with the leg spring 8, additionally has a damping device for torsional oscillations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A gearwheel assembly for the transmission of torque from one shaft to another shaft, said gearwheel assembly comprising:
a gearwheel;
a driver part arranged on said gearwheel; and
a damping device connecting said driver part to said gearwheel and allowing limited rotation of said driver part with respect to said gearwheel in order to damp torsional vibrations.

2. A gearwheel assembly as in claim 1 wherein said gearwheel has a mounting surface which receives said driver part, said driver part being profiled to interlock with a shaft in a defined angular position.

3. A gearwheel assembly as in claim 1 wherein said driver part has a cylindrical extension with a snap device for axially securing said gearwheel to said driver part.

4. A gearwheel assembly as in claim 1 wherein said driver part consists of sheet steel.

5. A gearwheel assembly as in claim 1 wherein
said driver part comprises a driver extension;
said gearwheel comprises a driver nose which is radially aligned with said driver extension; and
said damping device comprises a leg spring having a pair of substantially parallel legs on either side of said driver extension and said driver nose.

6. A gearwheel assembly as in claim 5 wherein said legs are prestressed against said driver extension and said driver nose.

7. A gearwheel assembly as in claim 5 wherein said damping device comprises a frictional connection.

8. A gearwheel assembly as in claim 7 wherein said leg spring has a turn which contacts itself to form said frictional connection.
